(19) United States
(12) Patent Application Publication
(10) Pub. No.: US 2005/0031977 A1
(43) Pub. Date: Feb. 10, 2005

(54) Naphthalene tetracarboxylic diimide based polymer, electrophotographic photoreceptor containing the same, and electrophotographic cartridge, electrophotographic drum and electrophotographic image forming apparatus comprising the electrophotographic photoreceptor

(75) Inventors: Seung-ju Kim, Suwon-si (KR); Beom-jun Kim, Seongnam-si (KR); Saburo Yokota, Suwon-si (KR); Kyung-yol Yon, Seongnam-si (KR); Hwan-Koo Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/875,676

(22) Filed: Jun. 25, 2004

(30) Foreign Application Priority Data
Jul. 3, 2003 (KR) 2003-44838

(51) Int. Cl. G03G 5/14

(52) U.S. Cl. 430/60; 399/159

(57) ABSTRACT

A naphthalene tetracarboxylic diimide based polymer having formula (1) below, and an electrophotographic photoreceptor, an electrophotographic cartridge, an electrophotographic drum and an electrophotographic image forming apparatus including the same, inhibit an injection of holes from an electroconductive substrate to minimize an image defect, 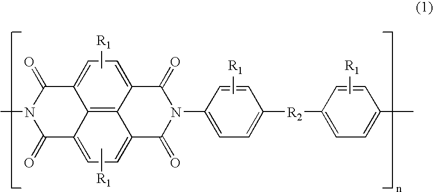
where R₁ is selected from the group consisting of: a hydrogen atom, a halogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ aralkyl group; R₂ is selected from the group consisting of: a C₁-C₂₀ substituted or unsubstituted alkylene group, a C₁-C₂₀ substituted or unsubstituted oxyalkylene group, a C₆-C₃₀ substituted or unsubstituted arylene group, and a C₇-C₃₀ aralkylene group, in which a substituting group is a halogen atom, an alkyl group, a halogenated alkyl group, an oxyalkyl group, or an aryl group; and n is an integer between 3 and 200, and preferably between 5 and 50.

### CROSS-REFERENCE TO RELATED APPLICATIONS

This application claims the benefit of Korean Patent Application No.2003-44838, filed on Jul. 3, 2003, in the Korean Intellectual Property Office, the disclosure of which is incorporated herein in its entirety by reference.

### BACKGROUND OF THE INVENTION

1. Field of the Invention

The present invention relates to a naphthalene tetracarboxylic diimide based polymer, an electrophotographic photoreceptor containing the same, and an electrophotographic cartridge, an electrophotographic drum and an electrophotographic image forming apparatus comprising the electrophotographic photoreceptor. More particularly, the present invention relates to a polymer having a repeat unit with a naphthalene tetracarboxylic diimide structure, an electrophotographic photoreceptor containing the polymer as an undercoat, and an electrophotographic cartridge, an electrophotographic drum and an electrophotographic image forming apparatus comprising the electrophotographic photoreceptor.

2. Description of the Related Art

Electrophotographic photoreceptors are used for electrophotographic facsimiles, photocopiers, laser printers, CRT printers, LED printers, LCD printers, and in the field of laser electrophotography. Meanwhile, the electrophotographic photoreceptors include a photoconductive layer containing a charge generating material, a charge transport material and a binder resin on an electroconductive substrate. A single-layered type photoconductive layer in which a charge generating material and a charge transport material are contained in one layer, or a laminated type photoconductive layer in which a charge generating layer containing the charge generating material and a charge transport layer containing the charge transport material are laminated are used as the photoconductive layer. Of these types, the laminated type is mainly used as the photoconductive layer.

However, when only the photoconductive layer is formed on the electroconductive substrate, surface defects, i.e., scratches, corrosion, impurities and the like, of the electroconductive substrate are reflected on an image, which is apt to cause image defects such as voids. Moreover, since adhesion between the electroconductive substrate and the photoconductive layer is poor, the entire photoconductive layer tends to peel, even for a small scratch. In addition, an injection of holes from the electroconductive substrate results in an increase of exposure potential. In order to resolve these problems, an undercoat is applied between the electroconductive substrate and the photoconductive layer.

Insulating organic polymers used as the undercoat are generally formed in the form of a thin film having a submicron thickness, but have a serious drawback in that sensitivity of the photoreceptor may be lowered. Further, space charges accumulate at the interface of the undercoat and the photoconductive layer, and the residual potential increases and the initial potential decreases, resulting in fatigue of the photoreceptor.

To overcome these drawbacks, various methods have been proposed, such as dispersing electroconductive inorganic fillers in the undercoat, using an ion conductive polymer, and including charge transport compounds or low molecular weight additives.

Examples of the inorganic filler include titanium oxide and tin oxide. When dispersing these fillers in a coating for the undercoat, technical difficulties arise in view of preparation or working life of the dispersion. Further, non-uniformity of the dispersion results in image defects.

Examples of the ion conductive polymer include water- or alcohol-soluble polymers, such as soluble polyamide and cellulose. These ion conductive polymers are inefficient due to their low electric conductivity.

Examples of the low molecular weight additive, which is conventionally used, include the compounds having formula (2) or (3) below:

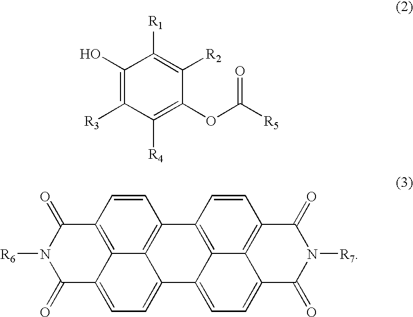

Also, a low molecular weight charge transport material having formula (4) below has been added and dispersed in a polymer resin to be used as the undercoat:

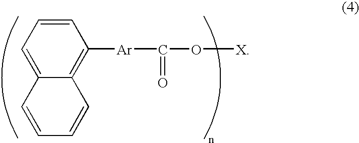

The polymer resin having the diphenoquinone structure having formula (5) below has been directly used as the undercoat as disclosed in U.S. Pat. No. 6,228,546:

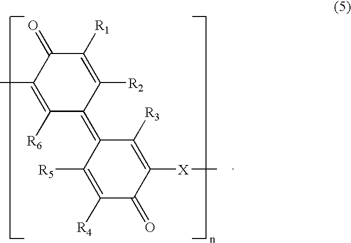

When the low molecular weight additive or the charge transport material is added to the polymer resin as described above, it is difficult to determine the optimal ratio of the additive or the charge transport material due to poor compatibility of the additives with the resin. Also, when the amount of the additive or the charge transport material added is increased, a crystallization or a phase isolation between the additive or the charge transport material and the polymer resin occurs. Meanwhile, when the addition amount is reduced, sufficient performance cannot be attained. In addition, due to lowered coating performance of the charge generating layer or the charge transport layer to the undercoat, it is very difficult to select a coating solution for the preparation of an electrophotographic photoreceptor.

It is disadvantageous to use the ion conductive polymer, for example, a water- or alcohol-soluble polymer such as soluble polyamide, or cellulose, as the undercoat, because the polymer is apt to be affected by ambient humidity.

### SUMMARY OF THE INVENTION

The present invention provides a polymer that inhibits an injection of holes from an electroconductive substrate to minimize an image defect and inhibit an increase of exposure potential, and that is not influenced by humidity when being used as an undercoat.

The present invention also provides an electrophotographic photoreceptor having a polymer to minimize an image defect and inhibit an increase of exposure potential.

The present invention also provides an electrophotographic cartridge, including an electrophotographic photoreceptor having a polymer to minimize an image defect and inhibit an increase of exposure potential.

The present invention also provides an electrophotographic drum, including an electrophotographic photoreceptor having a polymer to minimize an image defect and inhibit an increase of exposure potential.

The present invention also provides an electrophotographic image forming apparatus, including an electrophotographic photoreceptor having a polymer to minimize an image defect and inhibit an increase of exposure potential.

According to an aspect of the present invention, a naphthalenetetracarboxylic diimide based polymer has formula (1) below: 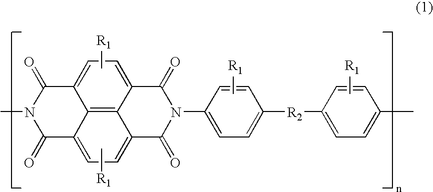
where R₁ is a hydrogen atom, a halogen atom, a C₁-C₂₀ substituted or unsubstituted alkyl group, a C₁-C₂₀ substituted or unsubstituted alkoxy group, a C₆-C₃₀ substituted or unsubstituted aryl group, or a C₇-C₃₀ aralkyl group; R₂ is a C₁-C₂₀ substituted or unsubstituted alkylene group, a C₁-C₂₀ substituted or unsubstituted oxyalkylene group, a C₆-C₃₀ substituted or unsubstituted arylene group, or a C₇-C₃₀ aralkylene group, in which a substituting group is a halogen atom, an alkyl group, a halogenated alkyl group, an oxyalkyl group, or an aryl group; and n is an integer between 3 and 200, and preferably between 5 and 50.

According to another aspect of the present invention, an electrophotographic photoreceptor includes: an electroconductive substrate, a photoconductive layer, and an undercoat interposed between the electroconductive substrate and the photoconductive layer, wherein the undercoat includes a polymer having formula (1) above.

According to another aspect of the present invention, an electrophotographic image forming apparatus includes: a plurality of support rollers; and an electrophotographic photoreceptor operably coupled to the support rollers, such that motion of the support rollers results in motion of the electrophotographic photoreceptor, wherein the electrophotographic photoreceptor includes an electroconductive substrate, a photoconductive layer, and an undercoat interposed between the electroconductive substrate and the photoconductive layer, and the undercoat contains a polymer having formula (1) above.

According to another aspect of the present invention, an electrophotographic cartridge includes: an electrophotographic photoreceptor including an electroconductive substrate, a photoconductive layer, and an undercoat interposed between the electroconductive substrate and the photoconductive layer, wherein the undercoat contains a polymer having formula (1) above; at least one of a charging device charging the electrophotographic photoreceptor, a developing device developing an electrostatic latent image formed on the electrophotographic photoreceptor, and a cleaning device cleaning a surface of the electrophotographic photoreceptor, and the electrophotographic cartridge is attachable to or detachable from an image forming apparatus.

According to another aspect of the present invention, an electrophotographic drum includes: a drum attachable to and detachable from an image forming apparatus; and an electrophotographic photoreceptor disposed on the drum, wherein the electrophotographic photoreceptor includes an electroconductive substrate, a photoconductive layer, and an undercoat interposed between the electroconductive substrate and the photoconductive layer, and the undercoat contains a polymer having formula (1) above.

According to another aspect of the present invention, an image forming apparatus includes: a photoreceptor unit including an electroconductive substrate, a photoconductive layer, and an undercoat interposed between the electroconductive substrate and the photoconductive layer, wherein the undercoat contains a polymer having formula (1) above; a charging device charging the photoreceptor unit; an imagewise light irradiating device irradiating light onto the charged photoreceptor unit to form an electrostatic latent image on the photoreceptor unit; a developing unit developing the electrostatic latent image with a toner to form a toner image on the photoreceptor unit; and a transfer device transferring the toner image onto a receiving material.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings, of which:

FIG. 1 is a block diagram illustrating (not to scale) an electrophotographic photoreceptor comprising an electroconductive substrate, a photoconductive layer and an undercoat interposed between the electroconductive substrate and the photoconductive layer in accordance with an embodiment of the present invention.

FIG. 2 is a schematic representation of an image forming apparatus, an electrophotgraphic drum, and an electrophographic cartridge in accordance with selected embodiments of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

An electrophotographic photoreceptor and an electrophotographic image forming apparatus, etc. according to the present invention will now be described in more detail.

The present invention includes a polymer having formula (1) below: 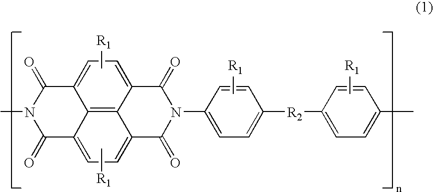
where R₁ is a hydrogen atom, a halogen atom, a C₁-C₂₀, preferably C₁-C₁₂, substituted or unsubstituted alkyl group, a C₁-C₂₀ substituted or unsubstituted alkoxy group, a C₆-C₃₀ substituted or unsubstituted aryl group, or a C₇-C₃₀ aralkyl group; R₂ is a C₁-C₂₀, preferably C₁-C₁₂, substituted or unsubstituted alkylene group, a C₁-C₂₀ substituted or unsubstituted oxyalkylene group, a C₆-C₃₀ substituted or unsubstituted arylene group, or a C₇-C₃₀ aralkylene group, in which a substituting group is a halogen atom, an alkyl group, a halogenated alkyl group, an oxyalkyl group, or an aryl group; and n is an integer between 3 and 200, and preferably between 5 and 50.

An example of the polymer having formula (1) is a polymer having formula (6) below:

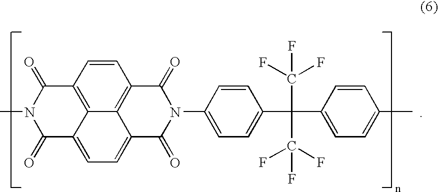

The polymer having formula (1) may be prepared by reacting naphthalenetetracarboxylic anhydride having formula (7) below with the diamine compound having formula (8) below.

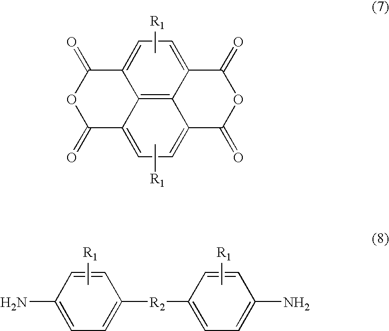

In formulas (7) and (8), R₁ and R₂ are the same as in formula (1).

The compound having formula (7) and the compound having formula (8) are added to an aprotic polar solvent, for example, dimethyl formamide, dimethyl acetamide or dimethyl sulfoxide, and refluxed. Then, a solution of 1:2 pyridine/acetic anhydride is added to the resulting solution and reacted at room temperature for an hour, then at 70° C. for 3 hours. Then, the resultant is cooled and precipitated in an alcoholic solvent, for example, methanol.

An electrophotographic photoreceptor containing the polymer having formula (1) in an undercoat according to the present invention will now be described in detail.

The photoreceptor according to an embodiment of the present invention is manufactured by sequentially laminating the undercoat that includes the polymer having formula (1) and a photoconductive layer on an electroconductive substrate.

A metal, such as aluminum or nickel, a metal deposited polymer film, a metal laminated polymer film, and the like may be used as the electroconductive substrate. Also, the electroconductive substrate may have a drum shape, a sheet shape or a belt shape.

The undercoat is formed as a thin film by dissolving the polymer compound having formula (1) in a solvent, and then applying the solution on the electroconductive substrate.

Examples of the solvent include aromatic solvents such as benzene, toluene, xylene, chlorobenzene; halogenated solvents such as dichloromethane, dichloroethane, chloroform, trichloroethane, tetrachloroethane, and carbon tetrachloride; esters such as methyl acetate, ethyl acetate, propyl acetate, methyl formate, and ethyl formate; ethers such as tetrahydrofuran; alcohols such as methanol, ethanol, and isopropyl alcohol; and aprotic polar solvents such as dimethyl formamide, dimethyl acetamide, and dimethyl sulfoxide. Among these solvents, ethers, halogenated solvents or mixed solvents thereof are preferred.

The method of forming the undercoat is not particularly restricted, and examples thereof include dip coating, bar coating, calender coating, gravure coating, spin coating, electro-deposition coating and spray coating.

The thickness of the undercoat is 1 to 5 μm, preferably 1 to 2 μm. When the thickness is less than 1 μm, it is difficult to inhibit hole injection from the electroconductive substrate. Meanwhile, when the thickness is greater than 5 μm, exposure potential increases and electrical properties deteriorate.

Then, a photoconductive layer is formed on the undercoat. The photoconductive layer may be a single-layered type or a laminated type. When the photoconductive layer is the laminated type, a charge generating layer and a charge transport layer are laminated after being separately formed, and the charge transport layer may contain one or both of a hole transport material and an electron transport material.

When the photoconductive layer is the single-layered type, the charge generating material and the hole transport material and/or the electron transport material are contained in one layer.

The laminated type photoconductive layer will now be described in more detail.

The charge generating layer contains a charge generating material, a binder resin and, if necessary, an additive, and may be formed by a coating process. The charge generating material is not particularly restricted and any organic or inorganic material that absorbs light of a particular wavelength and effectively generates charges may be used.

Examples of the charge generating material for use in the photoconductive layer include organic materials such as phthalocyanine pigment, azo pigment, quinone pigment, perylene pigment, indigo pigment, bisbenzoimidazole pigment, quinacridone pigment, azulenium dye, squarylium dye, pyrylium dye, triarylmethane dye, and cyanine dye, and inorganic materials such as amorphous silicon, amorphous selenium, trigonal selenium, tellurium, selenium-tellurium alloy, cadmium sulfide, antimony sulfide, and zinc sulfide. The charge generating materials for use in the photoconductive layer are not limited to the materials listed herein, and may be used alone or in a combination of two or more.

Examples of the binder resin for use together with the charge generating material include, but are not limited to, electrically insulating polymers, for example, polycarbonate, polyester, methacryl resin, acryl resin, polyvinyl chloride, polyvinylidene chloride, polystyrene, polyvinyl acetate, silicon resin, silicon-alkyd resin, styrene-alkyd resin, poly-N-vinylcarbazole, phenoxy resin, epoxy resin, polyvinyl butyral, polyvinyl acetal, polyvinyl formal, polysulfone, polyvinyl alcohol, ethyl cellulose, phenol resin, polyamide, carboxy-methyl cellulose, and polyurethane. These polymers may be used alone or in a combination of two or more.

Examples of the additive used, if necessary, include an antioxidant, a dispersant, an adhesion-assistant and a sensitizer.

The charge transport layer may be formed on the charge generating layer of the laminated type photoconductive layer, or the charge generating layer may be formed on the charge transport layer in reverse order.

The charge transport layer may be formed by applying a solution containing the charge transport material, the binder resin, and, if necessary, the additive on the charge generating layer and then drying. The solvent used is not particularly restricted and any solvent in which the binder resin dissolves and the charge generating layer does not dissolve may be used. Any commonly used charge transport material may be used. Examples of the charge transport material include hydrazone compounds, stilbene compounds, triarylamine compounds, pyrazoline compounds, oxadiazole compounds, oxazole compounds, polyvinylcarbazole compounds, and triphenylmethan compounds.

In the case of the single-layered type photoreceptor, the photoconductive layer is formed by applying a solution or a dispersion in which the charge generating material, the binder resin and the charge transport material are dissolved or dispersed on the electroconductive substrate. Although the hole transport material and the electron transport material may be used as the charge transport material, in the single-layered type photoreceptor, the hole transport material is preferably used together with the electron transport material.

Examples of the hole transport material include nitrogen containing cyclic compounds or condensed polycyclic compounds such as pyrene compounds, carbazole compounds, hydrazone compounds, oxazole compounds, oxadiazole compounds, pyrazoline compounds, arylamine compounds, arylmethane compounds, benzidine compounds, thiazole compounds or styryl compounds. Also, polymer compounds or polysilane compounds having a functional group of the above compounds on a backbone or a side chain may be used.

Examples of the electron transport material include, but are not limited to, electron attracting low molecular weight compounds such as benzoquinone compounds, cyanoethylene compounds, cyanoquinodimethane compounds, fluorenone compounds, xanthone compounds, phenanthraquinone compounds, phthalic anhydride compounds, thiopyrane compounds, or diphenoquinone compounds. Electron transport polymer compounds or pigments having n-type semiconductor characteristic may also be used.

The charge transport material or the hole transport material that may be used for the electrophotographic photoreceptor are not limited to the materials listed herein, and such materials may be used alone or in a combination of two or more.

The thickness of the photoconductive layer may be set in the range of 5 to 50 μm regardless of whether the photoconductive layer is the laminated type and the single-layered type.

The present invention will now be described in greater detail with reference to the following examples. The following examples are for illustrative purposes only, and are not intended to limit the scope of the invention.

### EXAMPLES

### Preparation Example: The compound (I)

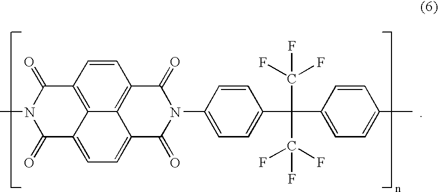

34 g (0.1 mol) of 4,4′-(hexafluoroisopropylidene)dianiline having formula (9) below and 26 g (0.1 mol) of 1,4,5,8-naphthalenetetracarboxylic anhydride were refluxed in 300 ml of DMF (dimethyl formamide) for 2 hours. After cooling the mixture to room temperature, 100 ml of a solution of 1:2 pyridine/acetic anhydride was added to the resulting solution and reacted at room temperature for 1 hour, then at 70° C. for 3 hours, followed by precipitating in 2000 ml of methanol. The precipitate was filtered and repeatedly purified by reprecipitating in methanol to obtain 35 g of the compound (I) having formula (6) (yield: about 60%).

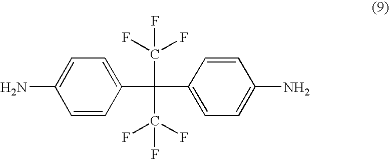

### Example 1

0.5 g of the compound (I) prepared in the above Preparation Example was dissolved in a solvent (9.5 g of THF, i.e., tetrahydrofuran)) and filtered (pore size=5 μm), and the solution was coated on an aluminum drum by a ring coating apparatus at a rate of 300 mm/min and dried at 70° C. for 30 minutes to form an undercoat having a thickness of about 2 μm.

3 g of milled gamma titanyl phthalocyanine (γ-TiOPc produced by H. W. SANDS, 15.23% by weight of ethanol) and 2 g of polyvinylbutyral resin (BX-1 produced by SEKISUKI) were added to 8.34 g of methylethylketone and filtered (pore size=5 μm), and the solution was coated on the undercoat by the ring coating apparatus at a rate of 300 mm/min and dried at 70° C. for 60 minutes to form a photoconductive layer having a thickness of about 1 μm. Thus, the charge generating layer was formed.

50 parts by weight of a hole transport material (MPCT 10 produced by MITSUBISHI PAPER MILLS) and 50 parts by weight of a binder resin (PCZ200 produced by MITSUBISHI CHEMICAL) were dissolved in 334 parts by weight of THF and filtered (pore size=5 μm), and the solution was coated on the charge generating layer by the ring coating apparatus at a rate of 300 mm/min and dried at 80° C. for 60 minutes to form a hole transport layer having a thickness of about 12 μm. Thus, the photoreceptor was formed.

### Comparative Example 1

A photoreceptor was formed in the same manner as in Example 1, except that the undercoat was not used.

### Comparative Example 2

A photoreceptor was formed in the same manner as in Example 1, except that 0.5 g of polyamide (CM8000 produced by AMILAN TORAY) was dissolved in 9.5 g of 2-chloroethanol and filtered (pore size=5 μm), and the solution was coated on an aluminum drum by the ring coating apparatus at a rate of 300 mm/min and dried at 120° C. for 30 minutes to form an undercoat having a thickness of about 2 μm.

### EXPERIMENTAL EXAMPLE

The charge potential and the exposure potential of each of the photoreceptors prepared in Example 1 and Comparative Examples 1 and 2 were measured using PDT-2000 manufactured by QEA. Each photoreceptor was charged by applying a voltage of 8 kV, and then exposed to an energy of 1 μJ/cm². The charge potential (V) and the exposure potential (Vᵣ) were measured at initial stage and after 500 cycles. The measurement results are shown in Table 1 below.

TABLE 1

| | V₀ | V₀ᵣ | V₅₀₀ | V₅₀₀ᵣ |
|---|---|---|---|---|
| Example 1 | 698.4 | 44.4 | 721.3 | 89.4 |
| Comparative | 619.1 | 35.6 | 586.8 | 51.1 |
| Example 1 | | | | |
| Comparative | 678.2 | 55.8 | 676.9 | 104.2 |
| Example 2 | | | | |

In the above Table 1, V₀ and V₅₀₀ represent the initial charge potential and the charge potential after 500 cycles, respectively, and V₀ᵣ and V₅₀₀ᵣ represent the initial exposure potential and the exposure potential after 500 cycles, respectively.

As shown in Table 1, the exposure potential of the photoreceptor of Example 1 according to an embodiment of the present invention increased less than that of the photoreceptor of Comparative Example 2, which used polyamide as an undercoat, after 500 cycles. The reason for this is that, for Example 1, the undercoat contains a polymer having the electron transporting structure such that an injection of holes from an electroconductive substrate may effectively be inhibited.

As described above, an electrophotographic photoreceptor including an undercoat containing a naphthalenetetracarboxylic diimide based polymer of the present invention may inhibit an injection of holes from an electroconductive substrate to minimize an image defect. Also, the electrophtographic photoreceptor may inhibit an increase of exposure potential, thus improving electrical properties.

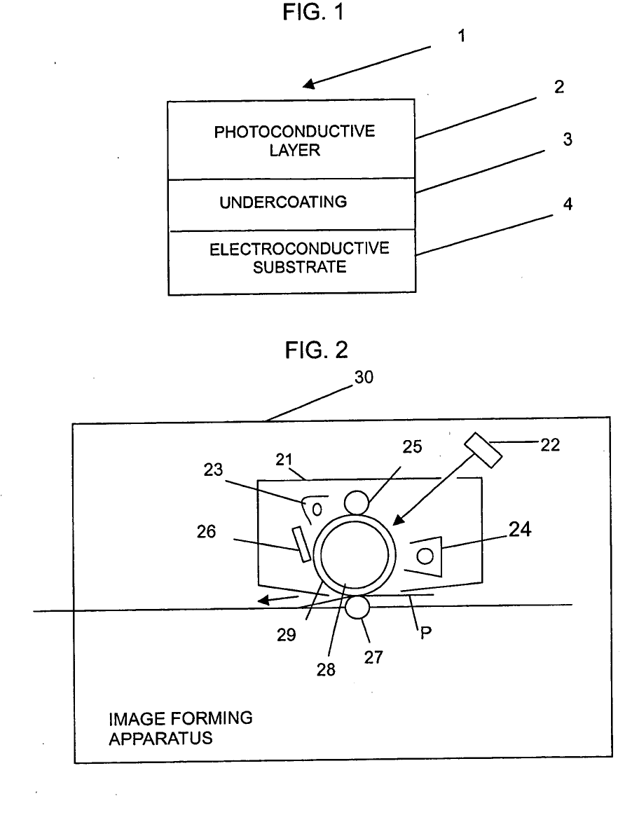

FIG. 1 is a block diagram illustrating (not to scale) an electrophotographic photoreceptor 1 comprising an electroconductive substrate 4, a photoconductive layer 2 and an undercoat 3 interposed between the electroconductive substrate 4 and the photoconductive layer 2 in accordance with an embodiment of the present invention.

FIG. 2 is a schematic representation of an image forming apparatus 30, an electrophotgraphic drum 28, and an electrophographic cartridge 21 in accordance with selected embodiments of the present invention. The electrophotographic cartridge 21 typically comprises an electrophotographic photoreceptor 29 and at least one of a charging device 25 that charges the electrophotographic photoreceptor 29, a developing device 24 which develops an electrostatic latent image formed on the electrophotographic photoreceptor 29, and a cleaning device 26 which cleans a surface of the electrophotographic photoreceptor 29. The electrophotographic cartridge 21 may be attached to or detached from the image forming apparatus 30, and the electrophotographic photoreceptor 29 is described more fully above.

The electrophotographic photoreceptor drum 28, 29 for an image forming apparatus 30, generally includes a drum 28 that is attachable to and detachable from the electrophotographic apparatus 30 and that includes an electrophotographic photoreceptor 29 disposed on the drum 28, wherein the electrophotographic photoreceptor 29 is described more fully above.

Generally, the image forming apparatus 30 includes a photoreceptor unit (e.g., an electrophotographic photoreceptor drum 28, 29), a charging device 25 which charges the photoreceptor unit, an imagewise light irradiating device 22 which irradiates the charged photoreceptor unit with imagewise light to form an electrostatic latent image on the photoreceptor unit, a developing unit 24 that develops the electrostatic latent image with a toner to form a toner image on the photoreceptor unit, and a transfer device 27 which transfers the toner image onto a receiving material, such as paper P, wherein the photoreceptor unit comprises an electrophotographic photoreceptor 29 as described in greater detail above. The charging device 25 may be supplied with a voltage as a charging unit and may contact and charge the electrophotographic receptor. Where desired, the apparatus may include a pre-exposure unit 23 to erase residual charge on the surface of the electrophotographic photoreceptor to prepare for a next cycle.

The electrophotographic image forming apparatus 30 includes a plurality of support rollers 25, 27 (in the embodiment shown, the support rollers are the charging drive 25 and the transfer device 27). The electrophotographic photoreceptor 29 is operably coupled to the support rollers 25, 27 such that motion of the support rollers 25, 27 results in motion of the electrophotographic photoreceptor 29.

Where desired, the photoreceptor may have a protective layer disposed thereon (not shown).

Although a few embodiments of the present invention have been shown and described, it would be appreciated by those skilled in the art that changes may be made in these embodiments without departing from the principles and spirit of the invention, the scope of which is defined in the claims and their equivalents.

1. A naphthalenetetracarboxylic diimide based polymer having formula (1) below: 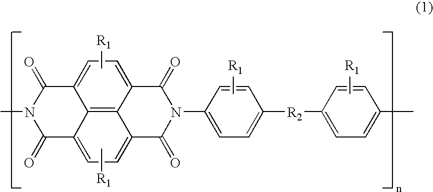
where R₁ is selected from the group consisting of: a hydrogen atom, a halogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ aralkyl group;
R₂ is selected from the group consisting of: a C₁-C₂₀ substituted or unsubstituted alkylene group, a C₁-C₂₀ substituted or unsubstituted oxyalkylene group, a C₆-C₃₀ substituted or unsubstituted arylene group, and a C₇-C₃₀ aralkylene group; and
n is an integer between 3 and 200.

2. An electrophotographic photoreceptor comprising:
an electroconductive substrate;
a photoconductive layer; and
an undercoat interposed between the electroconductive substrate and the photoconductive layer, the undercoat comprising a polymer having formula (1) below: 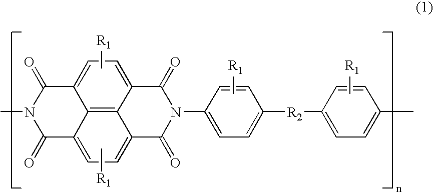
where R₁ is selected from the group consisting of: a hydrogen atom, a halogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ aralkyl group;
R₂ is selected from the group consisting of: a C₁-C₂₀ substituted or unsubstituted alkylene group, a C₁-C₂₀ substituted or unsubstituted oxyalkylene group, a C₆-C₃₀ substituted or unsubstituted arylene group, and a C₇-C₃₀ aralkylene group; and
n is an integer between 3 and 200.

3. The electrophotographic photoreceptor of claim 2, wherein the photoconductive layer is one of: a single-layered type and a laminated type.

4. An electrophotographic image forming apparatus comprising:
a plurality of support rollers; and
an electrophotographic photoreceptor operably coupled to the support rollers such that motion of the support rollers results in motion of the electrophotographic photoreceptor, the electrophotographic photoreceptor comprising:
an electroconductive substrate;
a photoconductive layer; and
an undercoat interposed between the electroconductive substrate and the photoconductive layer, the undercoat comprising a polymer having formula (1) below: 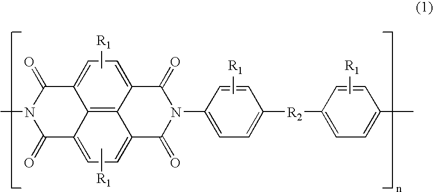
where R₁ is selected from the group consisting of: a hydrogen atom, a halogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ aralkyl group;
R₂ is selected from the group consisting of: a C₁-C₂₀ substituted or unsubstituted alkylene group, a C₁-C₂₀ substituted or unsubstituted oxyalkylene group, a C₆-C₃₀ substituted or unsubstituted arylene group, and a C₇-C₃₀ aralkylene group; and
n is an integer between 3 and 200.

5. The electrophotographic image forming apparatus of claim 4, wherein the photoconductive layer is one of: a single-layered type and a laminated type.

6. An electrophotographic cartridge comprising:
an electrophotographic photoreceptor comprising:
an electroconductive substrate;
a photoconductive layer; and
an undercoat interposed between the electroconductive substrate and the photoconductive layer, the undercoat comprising a polymer having formula (1) below: 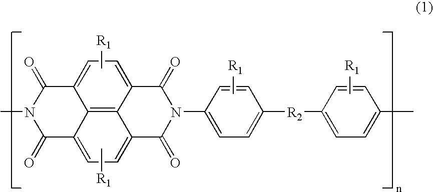
where R₁ is selected from the group consisting of: a hydrogen atom, a halogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ aralkyl group;
R₂ is selected from the group consisting of: a C₁-C₂₀ substituted or unsubstituted alkylene group, a C₁-C₂₀ substituted or unsubstituted oxyalkylene group, a C₆-C₃₀ substituted or unsubstituted arylene group, and a C₇-C₃₀ aralkylene group; and
n is an integer between 3 and 200; and
at least one of:
a charging device charging the electrophotographic photoreceptor;
a developing device developing an electrostatic latent image formed on the electrophotographic photoreceptor; and
a cleaning device cleaning a surface of the electrophotographic photoreceptor,
the electrophotographic cartridge being attachable to or detachable from the image forming apparatus.

7. The electrophotographic cartridge of claim 6, wherein the photoconductive layer is one of: a single-layered type and a laminated type.

8. An electrophotographic drum comprising:
a drum attachable to and detachable from an image forming apparatus; and
an electrophotographic photoreceptor disposed on the drum, the electrophotographic photoreceptor comprising:
an electroconductive substrate;
a photoconductive layer; and
an undercoat interposed between the electroconductive substrate and the photoconductive layer, the undercoat comprising a polymer having formula (1) below: 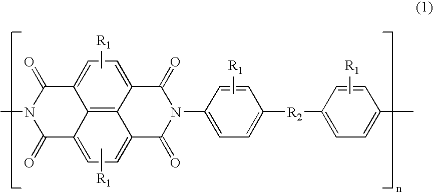
where R₁ is selected from the group consisting of: a hydrogen atom, a halogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ aralkyl group;
R₂ is selected from the group consisting of: a C₁-C₂₀ substituted or unsubstituted alkylene group, a C₁-C₂₀ substituted or unsubstituted oxyalkylene group, a C₆-C₃₀ substituted or unsubstituted arylene group, and a C₇-C₃₀ aralkylene group; and
n is an integer between 3 and 200.

9. The electrophotographic drum of claim 8, wherein the photoconductive layer is one of: a single-layered type and a laminated type.

10. An image forming apparatus comprising:
a photoreceptor unit comprising:
an electroconductive substrate;
a photoconductive layer; and
an undercoat interposed between the electroconductive substrate and the photoconductive layer, the undercoat comprising a polymer having formula (1) below: 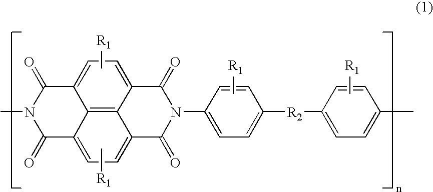
where R₁ is selected from the group consisting of: a hydrogen atom, a halogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ aralkyl group;
R₂ is selected from the group consisting of: a C₁-C₂₀ substituted or unsubstituted alkylene group, a C₁-C₂₀ substituted or unsubstituted oxyalkylene group, a C₆-C₃₀ substituted or unsubstituted arylene group, and a C₇-C₃₀ aralkylene group; and
n is an integer between 3 and 200;
a charging device charging the photoreceptor unit;
an imagewise light irradiating device irradiating light onto the charged photoreceptor unit to form an electrostatic latent image on the photoreceptor unit;
a developing unit developing the electrostatic latent image with a toner to form a toner image on the photoreceptor unit; and
a transfer device transferring the toner image onto a receiving material.

11. The image forming apparatus of claim 10, wherein the photoconductive layer is one of: a single-layered type and a laminated type.

12. The naphthalenetetracarboxylic diimide based polymer of claim 1, wherein the polymer comprises: 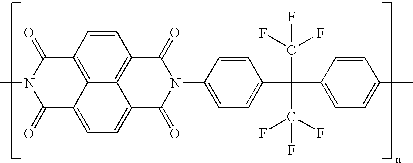
where n is an integer between 3 and 200.

13. The electrophotographic photoreceptor of claim 2, wherein the undercoat comprises: 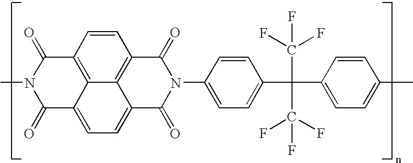
where n is an integer between 3 and 200.

14. The electrophotographic image forming apparatus of claim 4, wherein the undercoat comprises: 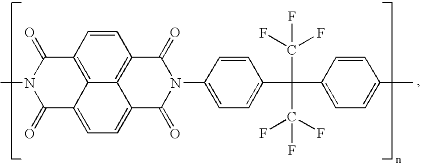
where n is an integer between 3 and 200.

15. The electrophotographic cartridge of claim 6, wherein the undercoat comprises: 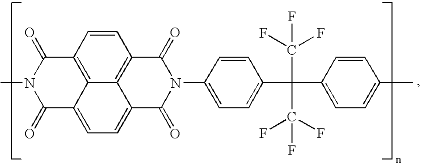
where n is an integer between 3 and 200.

16. The electrophotographic drum of claim 8, wherein the undercoat comprises: 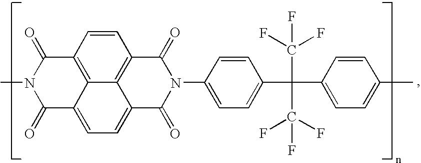
where n is an integer between 3 and 200.

17. The image forming apparatus of claim 10, wherein the undercoat comprises: 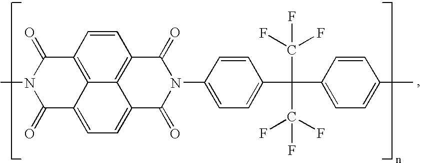
where n is an integer between 3 and 200.

18. The electrophotographic photoreceptor of claim 2, wherein the undercoat is 1 to 5 μm thick.

19. The electrophotographic image forming apparatus of claim 4, wherein the undercoat is 1 to 5 μm thick.

20. The electrophotographic cartridge of claim 6, wherein the undercoat is 1 to 5 μm thick.

21. The electrophotographic drum of claim 8, wherein the undercoat is 1 to 5 μm thick.

22. The image forming apparatus of claim 10, wherein the undercoat is 1 to 5 μm thick.

23. The electrophotographic photoreceptor of claim 3, wherein the laminated type photoconductive layer comprises:
a charge generating material; and
a binder resin.

24. The electrophotographic photoreceptor of claim 23, wherein the charge generating material comprises at least one of: phthalocyanine pigment, azo pigment, quinone pigment, perylene pigment, indigo pigment, bisbenzoimidazole pigment, quinacridone pigment, azulenium dye, squarylium dye, pyrylium dye, triarylmethane dye, cyanine dye, amorphous silicon, amorphous selenium, trigonal selenium, tellurium, selenium-tellurium alloy, cadmium sulfide, antimony sulfide, and zinc sulfide.

25. The electrophotographic photoreceptor of claim 23, wherein the binder resin comprises at least one of: polycarbonate, polyester, methacryl resin, acryl resin, polyvinyl chloride, polyvinylidene chloride, polystyrene, polyvinyl acetate, silicon resin, silicon-alkyd resin, styrene-alkyd resin, poly-N-vinylcarbazole, phenoxy resin, epoxy resin, polyvinyl butyral, polyvinyl acetal, polyvinyl formal, polysulfone, polyvinyl alcohol, ethyl cellulose, phenol resin, polyamide, carboxy-methyl cellulose, and polyurethane.

26. The electrophotographic photoreceptor of claim 23, wherein the laminated type photoconductive layer further comprises an additive.

27. The electrophotographic photoreceptor of claim 26, wherein the additive comprises at least one of: an antioxidant, a dispersant, an adhesion-assistant and a sensitizer.

28. The electrophotographic photoreceptor of claim 3, wherein the laminated type photoconductive layer comprises a charge generating layer and a charge transport layer, laminated after being separately formed, and the charge transport layer comprises at least one of a hole transport material and an electron transport material.

29. The electrophotographic photoreceptor of claim 3, wherein the single-layered type photoconductive layer comprises a combination of charge generating material and charge transporting material.

30. The electrophotographic photoreceptor of claim 29, wherein the charge transporting material comprises at least one of: a hole transport material and an electron transport material.

31. The electrophotographic photoreceptor of claim 30, wherein the hole transport material comprises at least one of: a nitrogen containing cyclic compound and a condensed polycyclic compound.

32. The electrophotographic photoreceptor of claim 30, wherein the electron transport material comprises at least one of: a benzoquinone compound, a cyanoethylene compound, a cyanoquinodimethane compound, a fluorenone compound, a xanthone compound, a phenanthraquinone compound, a phthalic anhydride compound, a thiopyrane compound, a diphenoquinone compound, an electron transport polymer compound and a pigment having an n-type semiconductor characteristic.
